(19) United States
(12) Patent Application Publication
(10) Pub. No.: US 2016/0319834 A1
(43) Pub. Date: Nov. 3, 2016

(54) ABRASIVELY MACHINED GAS TURBINE COMPONENTS

(71) Applicant: UNITED TECHNOLOGIES CORPORATION, Farmington, CT (US)

(72) Inventors: John P. Rizzo, JR., Vernon, CT (US); Darryl Slade Stolz, Newington, CT (US)

(73) Assignee: United Technologies Corporation, Farmington, CT (US)

(21) Appl. No.: 15/106,015

(22) PCT Filed: Nov. 19, 2014
(86) PCT No.: PCT/US2014/066341

§ 371 Date: Jun. 17, 2016

Related U.S. Application Data
(60) Provisional application No. 61/917,186, filed on Dec. 17, 2013.

(51) Int. Cl. F04D 29/32; F01D 5/02; B24B 19/14

(52) U.S. Cl. CPC F04D 29/321; B24B 19/14; F01D 5/02; F05D 2230/10; F05D 2300/17

(57) ABSTRACT

A method of making a gas turbine engine component includes providing a nickel based alloy workpiece and removing material from the workpiece surface using an abrasive machining operation to form an axisymmetric surface on the workpiece using the abrasive machining operation. The workpiece axisymmetric surface and workpiece interior portion have uniform hardness and micro structure following the removing operation.

### RELATED APPLICATIONS

This application claims the benefit of and priority to U.S. Provisional Patent Application No. 61/917,186 filed Dec. 17, 2013, the contents of which are incorporated herein by reference in their entirety

### BACKGROUND OF THE INVENTION

1. Field of the Invention

The present disclosure relates to gas turbine engines, and more particularly to methods of making gas turbine engine components.

2. Description of Related Art

Gas turbine engine components can be exposed to high temperature and extreme stress during operation. Some gas turbine components are formed from materials suited to such harsh conditions, such as nickel based superalloys. Such alloys are generally extremely hard and have excellent corrosion resistance. Some nickel based superalloys can maintain their mechanical properties at temperatures in excess of 80% of their melting point.

One challenge with forming engine components from extremely hard materials like nickel based superalloys is that they typically have relatively low machinability ratings. Conventional grinding processes generally have unacceptably slow material removal rates to work these materials. Since turning generally has a faster material removal rate than conventional grinding, turning is generally the process of choice for material removal operations. Turning, however, can induce surface damage and/or artifacts on surfaces of turned components that can reduce the expected fatigue life of the component. This offsets some of the advantages or turning over other types of material removal operations, and requires balancing the advantages of faster machining with the need to counteract (i.e. repair) surface and subsurface damage typically associated with turning processes.

Such conventional methods and systems have generally been considered satisfactory for their intended purpose. However, there is a continuing need in the art for gas turbine engine components and methods of making gas turbine components. The present disclosure provides a solution for these problems.

### SUMMARY OF THE INVENTION

A method of making a gas turbine engine component includes providing a nickel based alloy workpiece and removing material from the workpiece surface using an abrasive machining operation to form an axisymmetric surface on the workpiece. The workpiece axisymmetric surface and workpiece interior portion have uniform hardness and microstructure following the removing operation.

In certain embodiments, the workpiece can be a powder metallurgy preform. The workpiece can be a forging. The axisymmetric surface can define an inner diameter or an outer diameter, face or flange, of the gas turbine engine component. The axisymmetric surface can define a portion of a rotor, disk, side plate, cover plate or seal structure of the component, for example.

In accordance with certain embodiments, the abrasive machining process can be a grinding process. The removing operation can be a roughing operation, a finishing operation, or a single operation including both roughing and finishing operations. The roughing operation can remove more than 40% of the workpiece material by volume.

It is contemplated that residual compressive or tensile stress can be about the same in the axisymmetric surface and in the subsurface as in the interior portion of the workpiece following the abrasive machining operation, e.g. less than would be present following a conventional turning operation. The method can also include peening or polishing the axisymmetric surface to improve the fatigue life of the component formed by the method. It is also contemplated that the component can have an unpeened and unpolished ground surface.

A gas turbine engine disk is also provided. The disk includes an axisymmetric body formed from a nickel based alloy. The body defines a surface portion and includes subsurface and interior portions. The subsurface portion is adjacent to and radially inward from the surface portion. The interior portion is adjacent to and radially inward from the subsurface portion. The axisymmetric surface and subsurface and interior portions have uniform hardness and microstructure.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a cross-sectional side elevation view of a gas turbine engine constructed in accordance with the present disclosure, showing compressor and turbine disks;

FIG. 2 is a cross-sectional side elevation view of the compressor disk of FIG. 1, showing axisymmetric features of the disk;

FIG. 3 is a partial cross-sectional side view of the compressor disk of FIG. 1, showing interior, subsurface, and surface portions of the disk; and

FIG. 4 is a process flow diagram of a method of making the disk of FIG. 1, showing a roughing operation including an abrasive machining process.

### DETAILED DESCRIPTION OF THE PREFERRED EMBODIMENTS

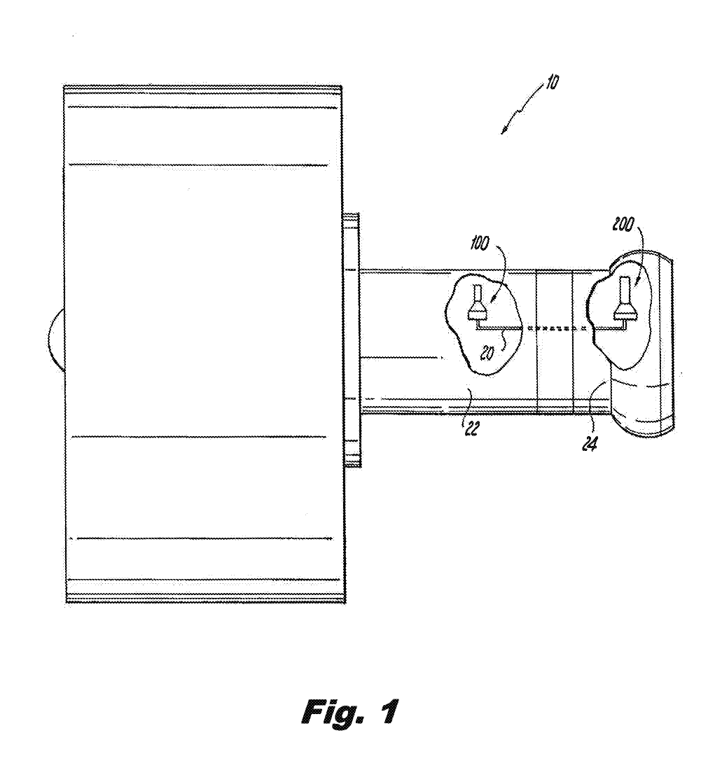

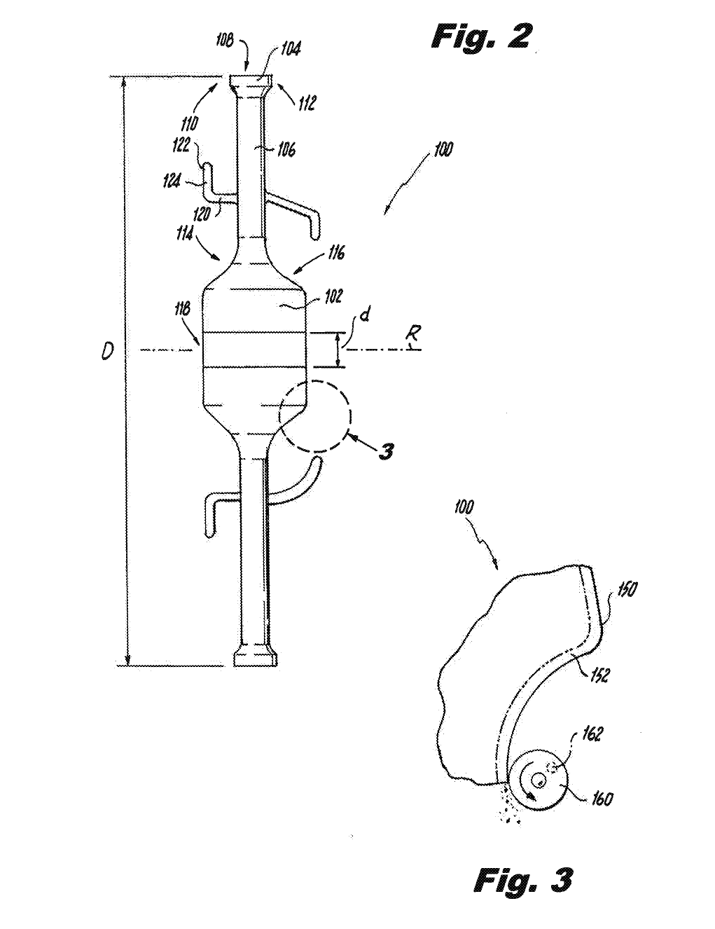

Reference will now be made to the drawings wherein like reference numerals identify similar structural features or aspects of the subject disclosure. For purposes of explanation and illustration, and not limitation, a partial view of an exemplary embodiment of a gas turbine engine in accordance with the disclosure is shown in FIG. 1 and is designated generally by reference character 10. Other embodiments of the component and methods of making the component in accordance with the disclosure, or aspects thereof, are provided in FIGS. 2-4, as will be described. The systems and methods described herein can be used for gas turbine engines, such as aircraft main engines for example.

Gas turbine engine 10 is a turbofan engine and includes a high-pressure compressor 22 and a high-pressure turbine 24 connected by a high-pressure shaft 26. High-pressure compressor 22 includes at least one high-pressure compressor disk 100 operatively associated with high-pressure shaft 26. High-pressure turbine 24 includes at least one high-pressure turbine disk 200 and is also operatively associated with high-pressure shaft 26. Each of high-pressure compressor disk 100 and high-pressure turbine disk 200 can be exposed to extreme stress and extremely high temperatures during operation.

With reference to FIG. 2, compressor disk 100 is shown. Compressor disk 100 is axisymmetric with respect to a rotations axis R extending through its center. Compressor disk 100 is formed from an extremely hard material with a relatively low machinability rating. Examples of such materials include nickel based or iron based alloys that are either wrought, such as Alloy 718, or nickel powder metallurgy forgings, such as IN100, ME16 or PRM48. Although a high-compressor disk is described herein, those skilled in the art will appreciate that the systems and apparatus described herein apply to other gas turbine engine components having axially symmetrical surfaces, such as fan disks, low-pressure compressor disks, and low-pressure and high-pressure turbine disks for example.

Compressor disk 100 includes a rim portion 102, a web portion 104, and a hub portion 106. Web portion 104 extends between rim portion 102 on it radially outward end and hub portion 106 on its radially inward end and couples rim portion 102 to hub portion 106. Rim portion 102 defines a plurality of axisymmetric surfaces including a first rim surface 108, a second rim surface 110, and a third rim surface 112. First rim surface 108 forms an outer diameter D of compressor disk 100 and extends about a circumference of compressor disk 100. Second rim surface 110 forms an axial face of compressor disk 100 oriented toward a forward end of gas turbine engine 10. Third rim surface 112 forms an opposed axial face of compressor disk 100 oriented toward an aft end of gas turbine engine 10. One or more of the first, second, and third surfaces 108, 110, and 112 has a ground surface defined using an abrasive machining process. The abrasively ground surface can be a finished surface that is neither polished nor peened which lacks the surface and subsurface damage typically associated with turning operations.

Hub portion 102 defines a first hub axisymmetric surface 114, a second hub axisymmetric surface 116, and an aperture 118. First and second hub axisymmetric surfaces 114 and 116 are axisymmetric with respect to rotation axis R. Aperture 118 is centrally disposed about rotation axis R and defines an inner diameter d of compressor disk 100. Web portion 106 has a plurality of axisymmetric surfaces and defines a side plate structure 120, a cover plate structure 122, and a seal structure 124.

With reference to FIG. 3, a portion of a nickel based preform workpiece for compressor disk 100 is shown. The illustrated portion of compressor disk 100 includes an interior portion 154, a subsurface portion 152, and an axisymmetric surface 150. Interior portion 154 is adjacent to and inward (relative to the component surface) of subsurface portion 152. Subsurface portion 152 envelopes interior portion 154. Subsurface portion 152 is adjacent to and inward of axisymmetric surface 150, and has a depth about equal to that susceptible to damage during conventional turning operations—about 25 microns in Alloy 718 for example. Axisymmetric surface 150 bounds subsurface portion 152, and is formed using an abrasive machining process.

Axisymmetric surface 150 is formed using a chip generating abrasive grinding tool, such as rotating grinding tool 160. Rotating grinding tool 160 includes an abrasive material 162 fixed in a matrix material 164. Abrasive material 162 can be a ceramic alumina abrasive material, such as Targa® available from Saint-Gobain Abrasives, Inc. of Worchester, Mass. Abrasive material 162 can also be a precision ceramic alumina abrasive material, such as Cubitron™ II available from 3M, Inc. of St. Paul, Minn. Grinding nickel based wrought and powder metallurgy forgings with ceramic alumina materials allows for material removal rates significantly higher than possible using conventional turning processes. Increased material removal rates in turn can provide material removal rates faster than conventional turning processes. This in turn potentially allows for rapid removal large amounts of material from extremely hard preforms, upwards of 80% of the component material by initial weight or volume for example.

In embodiments, the abrasive machining methods described herein can provide greater material removal rates than achievable with conventional turning operations without inducing surface damage that can require removal following conventional turning operations. This potentially avoids the need to follow such turning operations with polishing operations. As will be appreciated by those skilled in the art, abrasive removal processes remove similar amounts of material to turning or milling operations for purposes of creating surfaces and modifying geometry. In contrast, polishing processes remove relatively little material and are used for changing surface roughness or finish.

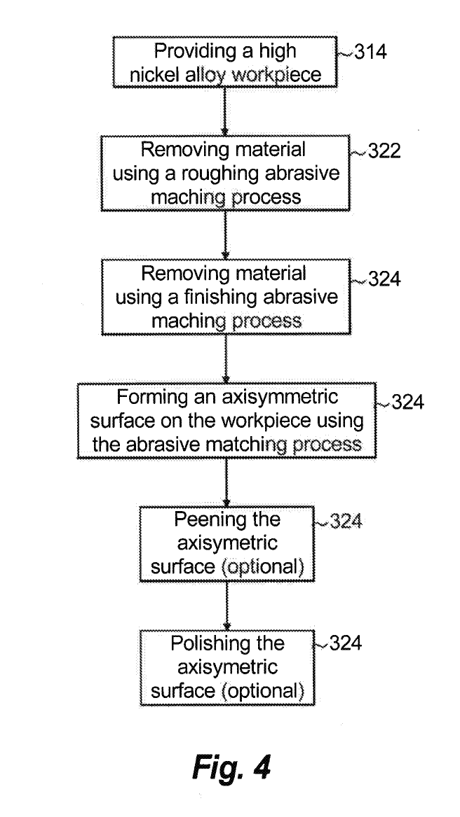

With reference to FIG. 4, a method 300 of making a gas turbine engine component is shown. Method 300 includes (a) providing 310 a nickel based alloy workpiece, and (b) removing 320 material from the workpiece surface using an abrasive machining process to form an axisymmetric surface on the workpiece using the abrasive machining process. Providing 310 can include providing a high nickel alloy workpiece or a preform formed using a powder metallurgy process. Removing 320 can include a first material removal operation 322, wherein a first portion of the workpiece is removed using an abrasive machining roughing process. The first material removal operation can entail removing between about 20% and about 40% of the workpiece. Removing 320 can be followed by a second material removal operation 324, wherein a second portion of the workpiece is removed using an abrasive machining finishing process. A forming 340 operation for defining an axisymmetric surface of the workpiece using the axisymmetric surface can follow removing operation 320. Optionally, the second material removal operation can have a slower material removal rate than the first removing operation. The gas turbine engine component formed by the method includes an axisymmetric surface, subsurface, and interior portion with uniform hardness and microstructure following the each of the material removal operations.

Optionally, method 300 can include at least one of peening 350 the axisymmetric surface and subsurface portion and/or polishing 360 the axisymmetric surface to improve expected fatigue life of the component. This can potentially improve the component expected fatigue life in comparison to that of a component formed using a conventional turning operation.

Rotor life can be limited by the manufacturing process used to fabricate the rotor. In particular, fatigue life is heavily influenced by surface condition. Conventional turning processes tend to leave surface features (i.e. damage) that can potentially limit the expected life of the turned part. Most turned surfaces, e.g. cylindrical surfaces, are peened after turning operations to induce a residual stress field in the surface and within the subsurface to counteract surface features left by turning operations. By defining the geometry of disk 100 with an abrasive machining process, such as a superabrasive ceramic alumina material, surface features associated with turning operations are not placed into surface and subsurface of disk 100. Axisymmetric surface 150, subsurface portion 152, and interior portion 154 each have substantially identical microstructure. For this same reason, residual stress (compressive or tensile) is substantially uniform in axisymmetric surface 150, subsurface portion 152, and interior portion 154. Advantageously, axisymmetric surface 150 need not undergo a polishing or peening operation subsequent to machining to improve expected fatigue life. However, axisymmetric surface 150 can optionally be peened to improve expected fatigue life, potentially increasing the expected lifetime of disk 100 beyond that possible with a disk formed by conventional turning and/or polishing and peening operations. This potentially allows components having ground, unpeened surfaces formed using the abrasive grinding methods described herein to have equivalent life to components that have been lathe turned and shot peened.

The methods and systems of the present disclosure, as described above and shown in the drawings, provide for gas turbine engine components and methods of making such components with superior properties including improved microstructure uniformity in the surface and subsurface and interior portions following the roughing operation. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method of machining a nickel based gas turbine component, comprising:
providing a nickel based alloy workpiece;
removing material from the workpiece using an abrasive machining process to form an axisymmetric surface on the workpiece using the abrasive machining process, wherein the axisymmetric surface and interior portion of the workpiece have uniform hardness and microstructure following the removing operation.

2. A method as recited in claim 1, wherein the removing step includes forming an unpeened and unpolished ground axisymmetric surface.

3. A method as recited in claim 1, wherein the removing step includes inducing residual stress in the axisymmetric surface and the subsurface portion that is substantially the same as residual stress in the interior portion.

4. A method as recited in claim 1, wherein the removing step includes inducing residual tensile stress in the subsurface portion that is the substantially the same as tensile stress within the interior portion.

5. A method as recited in claim 1, wherein the removing step includes inducing residual compressive stress in the subsurface portion that is substantially the same as compressive stress within the interior portion.

6. A method as recited in claim 1, where the workpiece is a forging.

7. A method as recited in claim 1, wherein the workpiece is a powder metallurgy preform.

8. A method as recited in claim 1, wherein the abrasive machining process includes an grinding process.

9. A method as recited in claim 1, wherein removing operation is a roughing operation.

10. A method as recited in claim 9, wherein the roughing operation removes between about between 20% and 80% of the workpiece by volume or weight.

11. A method as recited in claim 1, wherein the removing operation is a roughing and a finishing operation.

12. A method for forming a gas turbine disk, comprising:
providing a nickel based workpiece;
removing a first portion of workpiece material in a roughing operation using an abrasive machining process, wherein the abrasive machining process removes between about 20% and about 80% of the workpiece by volume or weight; and
removing a second portion of workpiece material in a finishing operation using the abrasive machining process, wherein the each removing operation forms an axisymmetric surface, wherein the axisymmetric surface, subsurface, and interior portion of the workpiece have substantially uniform hardness and microstructure following the removing operation.

13. A method as recited in claim 12, wherein the abrasive machining process is a grinding process.

14. A method as recited in claim 12, wherein residual stress in axisymmetric surface, subsurface portion, and interior portion is substantially the same following the removing operation.

15. A method as recited in claim 12, further including peening the axisymmetric surface following the finishing operation.

16. A gas turbine engine disk, comprising:
a nickel based alloy body, defining:
a ground axisymmetric surface;
a subsurface portion adjacent to and axially inward of the axisymmetric surface; and
an interior portion adjacent to and axially inward of the subsurface portion, wherein the axisymmetric surface, subsurface portion, and interior portion have substantially uniform hardness and microstructure.

17. A disk as recited in claim 16, wherein the ground axisymmetric surface is an unpeened and unpolished ground surface.

18. A disk as recited in claim 16, wherein residual stress within the axisymmetric surface, the subsurface portion, and interior portion is substantially the same.

19. A disk as recited in claim 16, wherein residual tensile stress in the subsurface portion is substantially the same as tensile stress within the interior portion.

20. A disk as recited in claim 16, wherein residual compressive stress in the subsurface is substantially the same as compressive stress in the interior portion.
